(19) United States
(12) Patent Application Publication
(10) Pub. No.: US 2024/0018446 A1
(43) Pub. Date: Jan. 18, 2024

(54) LAUNDRY DETERGENT COMPOSITION CONTAINING TWO GRAFT COPOLYMER

(71) Applicant: The Procter & Gamble Company, Cincinnati, OH (US)

(72) Inventors: Giulia Ottavia BIANCHETTI, Laken (BE); Renae Dianna FOSSUM, Middletown, OH (US); Amanda Kiser JUKES, Brussels (BE); Michael Ray MCDONALD, Liberty Township, OH (US)

(21) Appl. No.: 18/326,100

(22) Filed: May 31, 2023

(30) Foreign Application Priority Data
Jul. 11, 2022 (EP) 22184001.0

(51) Int. Cl. C11D 3/37; C11D 11/00; C11D 1/83; C11D 3/50; C11D 17/04

(52) U.S. Cl. CPC C11D 3/3788; C11D 11/0017; C11D 1/83; C11D 3/50; C11D 17/043; C11D 17/045; C11D 1/72

(57) ABSTRACT

A laundry detergent composition containing two graft copolymers.

### FIELD OF THE INVENTION

The present invention relates to a laundry detergent composition containing two graft copolymers.

### BACKGROUND OF THE INVENTION

As detergent products are evolving, consumer needs in the term of cleaning have been well met. However, there are still some other unmet consumer needs in the field of laundry. Particularly, the unmet needs include additional benefits for fabrics after washing, e.g. a delightful scent, brightening, degerming, anti-malodor, softening, and insect repelling. Especially, perfumes have typically been used to help counteract malodour and also to make clothing smell “fresh”. In order to deliver such freshness, it is known that perfume can be added into laundry products.

However, the freshness is often unsatisfactory due to insufficient deposition of such perfume onto fabrics after washing. Accordingly, it may be desirable to have technologies to improve the deposition of perfume onto fabrics.

### SUMMARY OF THE INVENTION

It is a surprising and unexpected discovery of the present invention that the combination of two graft copolymers in a detergent formulation can deliver a synergistic effect on the deposition of perfume, resulting in improved freshness.

Correspondingly, the present invention in one aspect relates to a laundry detergent composition, comprising:
1) a first graft copolymer comprising:
a) polyalkylene oxide component as a graft base which has a number average molecular weight of from 1000 to 20,000 Daltons and is based on ethylene oxide, propylene oxide, butylene oxide or mixtures thereof;
b) N-vinylpyrrolidone; and
c) vinyl ester derived from a saturated monocarboxylic acid containing from 1 to 6 carbon atoms and/or a methyl or ethyl ester of acrylic or methacrylic acid;
wherein the weight ratio of (a):(b) is from 1:0.1 to 1:2, and
wherein the amount, by weight, of (a) is greater than the amount of (c);
2) a second graft copolymer comprising:
i) polyalkylene oxide component as a graft base which preferably has a number average molecular weight of from 1000 to 20,000 Daltons and is based on ethylene oxide, propylene oxide, butylene oxide or mixtures thereof; and
ii) vinyl ester component as side chains which is preferably derived from a saturated monocarboxylic acid containing from 1 to 6 carbon atoms and/or a methyl or ethyl ester of acrylic or methacrylic acid;
and
3) a perfume.

In one embodiment according to the present application, the weight ratio of the first graft copolymer to the second graft copolymer is from 20:1 to 1:20, preferably from 10:1 to 1:10, more preferably from 5:1 to 1:5, most preferably from 3:1 to 1:3.

In one embodiment according to the present application, the total amount of the first graft copolymer and the second graft copolymer is from 0.05% to 3%, preferably from 0.05% to 2.5%, more preferably from 0.1% to 2%, yet more preferably from 0.15% to 1.5%, yet more preferably from 0.2% to 1%, most preferably 0.2% to 0.7%, e.g. 1%, 0.9%, 0.8%, 0.7%, 0.6%, 0.5%, 0.4%, 0.2% or any ranges therebetween, by weight of the composition.

In one embodiment according to the present application, in the first graft copolymer:
a) the polyalkylene oxide comprises and preferably consists of ethylene oxide units or ethylene oxide units and propylene oxide units, and
c) the vinyl ester comprises and preferably consists of vinyl acetate.

In one embodiment according to the present application, in the first graft copolymer, the polyalkylene oxide has a number average molecular weight of from 2000 to 15,000 Daltons.

In one embodiment according to the present application, in the first graft polymer, the weight ratio of (a):(c) is from 1.0:0.1 to 1.0:0.99, preferably from 1.0:0.3 to 1.0:0.9.

In one embodiment according to the present application, in the first graft polymer, from 1.0 mol % to 60 mol %, preferably from 20 mol % to 60 mol %, more preferably from 30 mol % to of the grafted-on monomers of component (c) are hydrolysed.

In one embodiment according to the present application, the first graft polymer has a weight average molecular weight of from 4,000 Da to 100,000 Da, preferably 5,000 Da to 100,000 Da, more preferably from 5,000 Da to 50,000 Da, most preferably from 8,000 Da to 20,000 Da.

Preferably, the second graft copolymer has an average of greater than 0 to less than or equal to 1 graft site per 50 alkylene oxide units, and/or the second graft copolymer has from 20% to 70%, preferably from 25% to 60%, by weight of said polymer of the polyalkylene oxide component and from 30% to 80%, preferably from 40% to 75%, by weight of said polymer of the vinyl ester component, and/or the second graft copolymer has a mean molar mass Mw of from 3,000 to 60,000, preferably from 6,000 to 45,000; and/or the second graft copolymer has a polydispersity of less than or equal to 3; and/or the second graft copolymer comprises less than or equal to 10% by weight of the polyvinyl ester in ungrafted form; and/or the second graft copolymer comprises side chains consisting of the vinyl ester component.

In one embodiment according to the present application, the composition comprises:
from about 0.01% to about 5%, preferably from about 0.05% to about 2%, more preferably from about 0.1% to about 1%, and most preferably from about 0.1% to about 0.5%, by weight of the composition, of the first graft copolymer, and/or
from about 0.01% to about 5%, preferably from about 0.05% to about 2%, more preferably from about 0.1% to about 1%, and most preferably from about 0.1% to about 0.5%, by weight of the composition, of the second graft copolymer, and/or
from about 0.001% to about 5%, preferably from about 0.005% to about 3%, more preferably from about 0.008% to about 2%, and most preferably from about 0.01% to about 1%, by weight of the composition, of the perfume.

In one embodiment according to the present application, the composition further comprises from 0.1% to 70%, preferably from 1% to 50%, more preferably from 5% to 40%, most preferably from 10% to 35%, by weight of the composition, of a surfactant.

In one embodiment according to the present application, the surfactant comprises C₆-C₂₀ linear alkylbenzene sulfonate (LAS), C₆-C₂₀ alkyl alkoxy sulfates (AAS), C₆-C₂₀ alkoxylated alcohol, or any mixtures thereof.

In one embodiment according to the present application, the composition may further comprise a treatment adjunct which may be preferably selected from the group consisting of a surfactant system, fatty acids and/or salts thereof, soil release polymers, hueing agents, builders, chelating agents, dye transfer inhibiting agents, dispersants, enzyme stabilizers, anti-oxidants, catalytic materials, bleach catalysts, bleach activators, polymeric dispersing agents, soil removal/anti-redeposition agents, polymeric grease cleaning agents, amphiphilic copolymers, suds suppressors, dyes, hueing agents, structure elasticizing agents, carriers, fillers, hydrotropes, solvents, anti-microbial agents and/or preservatives, neutralizers and/or pH adjusting agents, processing aids, rheology modifiers and/or structurants, opacifiers, pearlescent agents, pigments, anti-corrosion and/or anti-tarnishing agents, and mixtures thereof.

In one embodiment according to the present application, said composition is in the form of a liquid composition, a granular composition, a single-compartment pouch, a multi-compartment pouch, a sheet, a pastille or bead, a fibrous article, a tablet, a bar, flake, or a mixture thereof. In one embodiment, the composition is added to a washing machine dispenser, or directly to the drum, manually or automatically in an auto-dosing machine.

In another aspect, the present application is related to the use of a laundry detergent composition according to the present application for improving the deposition of the perfume onto fabrics, especially synthetic fabrics.

In another aspect, the present application is related to a method of treating textile, the method comprising the steps of: (i) treating a textile with a laundry detergent composition according to the present application; and (ii) treating the textile with a fabric enhancer composition comprising a perfume. Particularly, the fabric enhancer composition is a solid fabric enhancer composition and Step (ii) occurs when the textile is washed. Alternatively, the fabric enhancer composition is a liquid fabric enhancer composition and Step (ii) occurs when the textile is rinsed.

### DETAILED DESCRIPTION OF THE INVENTION

### Definitions

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

As used herein, when a composition is “substantially free” of a specific ingredient, it is meant that the composition comprises less than a trace amount, alternatively less than 0.1%, alternatively less than 0.01%, alternatively less than 0.001%, by weight of the composition, of the specific ingredient.

As used herein, the term “laundry detergent composition” means a composition for cleaning soiled materials, including fabrics. Such compositions may be used as a pre-laundering treatment, a post-laundering treatment, or may be added during the rinse or wash cycle of the laundering operation, may be added manually by the consumer or automatically by an automatic dispensing machine. The laundry detergent composition compositions may have a form selected from liquid, powder, unit dose such as single-compartment or multi-compartment unit dose, pouch, tablet, gel, paste, bar, or flake. Preferably, the laundry detergent composition is a liquid or a unit dose composition. The term of “liquid laundry detergent composition” herein refers to compositions that are in a form selected from the group consisting of pourable liquid, gel, cream, and combinations thereof. The liquid laundry detergent composition may be either aqueous or non-aqueous, and may be anisotropic, isotropic, or combinations thereof. The term of “unit dose laundry detergent composition” herein refers to a water-soluble pouch containing a certain volume of liquid wrapped with a water-soluble film.

As used herein, the term “alkyl” means a hydrocarbyl moiety which is branched or unbranched, substituted or unsubstituted. Included in the term “alkyl” is the alkyl portion of acyl groups.

As used herein, the term “washing solution” refers to the typical amount of aqueous solution used for one cycle of laundry washing, from 1 L to 65 L, preferably from 1 L to 50 L, alternatively from 1 L to 20 L for hand washing and from 10 L to 50 L for machine washing.

As used herein, the term “soiled fabric” is used non-specifically and may refer to any type of natural or artificial fibers, including natural, artificial, and synthetic fibers, such as, but not limited to, cotton, linen, wool, polyester, nylon, silk, acrylic, and the like, as well as various blends and combinations.

### Composition

The compositions of the present disclosure may be selected from the group of light duty liquid detergents compositions, heavy duty liquid detergent compositions, detergent gels commonly used for laundry, bleaching compositions, laundry additives, fabric enhancer compositions, and mixtures thereof.

The composition may be in any suitable form. The composition may be in the form of a liquid composition, a granular composition, a single-compartment pouch, a multi-compartment pouch, a sheet, a pastille or bead, a fibrous article, a tablet, a bar, flake, or a mixture thereof. The composition can be selected from a liquid, solid, or combination thereof.

The composition can be an aqueous liquid laundry detergent composition. For such aqueous liquid laundry detergent compositions, the water content can be present at a level of from 5.0% to %, preferably from 25% to 90%, more preferably from 50% to 85% by weight of the liquid detergent composition.

The pH range of the detergent composition is from 6.0 to 8.9, preferably from pH 7 to 8.8.

The detergent composition can also be encapsulated in a water-soluble film, to form a unit dose article. Such unit dose articles comprise a detergent composition of the present invention, wherein the detergent composition comprises less than 20%, preferably less than 15%, more preferably less than 10% by weight of water, and the detergent composition is enclosed in a water-soluble or dispersible film. Such unit-dose articles can be formed using any means known in the art. Suitable unit-dose articles can comprise one compartment, wherein the compartment comprises the liquid laundry detergent composition. Alternatively, the unit-dose articles can be multi-compartment unit-dose articles, wherein at least one compartment comprises the liquid laundry detergent composition.

### First Graft Copolymers

The detergent composition may comprise a first graft copolymer. The first graft copolymer can be present at a level of from about 0.01% to about 15%, preferably from about 0.05% to about 10%, more preferably from about 0.1% to about 5%, and most preferably from about 0.2% to about 3%, e.g. 0.1%, 0.15%, 0.2%, 0.25%, 0.3%, 0.35%, 0.4%, 0.45%, 0.5%, 1%, 2%, or 3%, by weight of the composition.

The first graft copolymer comprises: (a) polyalkylene oxide which has a number average molecular weight of from 1000 to 20,000 Daltons and is based on ethylene oxide, propylene oxide, or butylene oxide, (b) N-vinylpyrrolidone, and (c) vinyl ester derived from a saturated monocarboxylic acid containing from 1 to 6 carbon atoms, wherein the weight ratio of (a):(b) is from 1:0.1 to 1:2, preferably from 1:0.1 to 1:1, more preferably from 1:0.3 to 1:1, and wherein the amount, by weight, of (a) is greater than the amount of (c).

The weight ratio of (a):(c) is from 1.0:0.1 to 1.0:0.99, or from 1.0:0.3 to 1.0:0.9. The weight ratio of (b):(c) can be from 1.0:0.1 to 1.0:5.0, or to 1.0:4.0.

The amount, by weight of the polymer, of (a) is greater than the amount of (c). The polymer may comprise at least 50% by weight, preferably at least 60% by weight, more preferably at least 75% by weight of (a) polyalkylene oxide.

The first graft copolymer comprises and/or is obtainable by grafting (a) a polyalkylene oxide which has a number average molecular weight of from 1000 to 20000 Da, or to 15000, or to 12000 Da, or to 10000 Da and is based on ethylene oxide, propylene oxide, or butylene oxide, preferably based on ethylene oxide, with (b) N-vinylpyrrolidone, and further with (c) a vinyl ester derived from a saturated monocarboxylic acid containing from 1 to 6 carbon atoms, preferably a vinyl ester that is vinyl acetate or a derivative thereof.

Suitable polyalkylene oxides may be based on homopolymers or copolymers, with homopolymers being preferred. Suitable polyalkylene oxides may be based on homopolymers of ethylene oxide or ethylene oxide copolymers having an ethylene oxide content of from 40 mol % to 99 mol %. Suitable comonomers for such copolymers may include propylene oxide, n-butylene oxide, and/or isobutylene oxide. Suitable copolymers may include copolymers of ethylene oxide and propylene oxide, copolymers of ethylene oxide and butylene oxide, and/or copolymers of ethylene oxide, propylene oxide, and at least one butylene oxide. The copolymers may include an ethylene oxide content of from 40 to 99 mol %, a propylene oxide content of from 1.0 to 60 mol %, and a butylene oxide content of from 1.0 to 30 mol %. The graft base may be linear (straight-chain) or branched, for example a branched homopolymer and/or a branched copolymer.

Branched copolymers may be prepared by addition of ethylene oxide with or without propylene oxides and/or butylene oxides onto polyhydric low molecular weight alcohols, for example trimethylol propane, pentoses, or hexoses.

The alkylene oxide unit may be randomly distributed in the polymer or be present therein as blocks.

The polyalkylene oxides of component (a) may be the corresponding polyalkylene glycols in free form, that is, with OH end groups, or they may be capped at one or both end groups. Suitable end groups may be, for example, C1-C25-alkyl, phenyl, and C1-C14-alkylphenyl groups. The end group may be a C1-alkyl (e.g., methyl) group. Suitable materials for the graft base may include PEG 300, PEG 1000, PEG 2000, PEG 4000, PEG 6000, PEG 8000, PEG 10000, PEG 12000, and/or PEG 20000, which are polyethylene glycols, and/or MPEG 2000, MPEG 4000, MPEG 6000, MPEG 8000 and MEG 10000 which are monomethoxypolyethylene glycols that are commercially available from BASF under the tradename PLURIOL and/or block copolymers made from ethylene oxide-propylene oxide-ethylene oxide (EO-PO-EO) or from propylene oxide-ethylene oxide-propylene oxide (PO-EO-PO) such as PE 6100, PE 6800 or PE 3100 commercially available from BASF under the tradename PLURONIC.

The first graft copolymer of the present disclosure may be characterized by relatively low degree of branching (i.e., degree of grafting). In the first graft copolymer of the present disclosure, the average number of grafting sites may be less than or equal to 1.0, or less than or equal to 0.8, or less than or equal to 0.6, or less than or equal to 0.5, or less than or equal to 0.4, per 50 alkylene oxide groups, e.g., ethylene oxide groups. The first graft copolymer may comprise, on average, based on the reaction mixture obtained, at least 0.05, or at least 0.1, graft site per 50 alkylene oxide groups, e.g., ethylene oxide groups. The degree of branching may be determined, for example, by means of ¹³C NMR spectroscopy from the integrals of the signals of the graft sites and the —CH₂— groups of the polyalkylene oxide.

The number of grafting sites may be adjusted by manipulating the temperature and/or the feed rate of the monomers. For example, the polymerization may be carried out in such a way that an excess of component (a) and the formed graft copolymer is constantly present in the reactor. For example, the quantitative molar ratio of component (a) and polymer to ungrafted monomer (and initiator, if any) is generally greater than or equal to 10:1, or to 15:1, or to 20:1.

The polyalkylene oxides are grafted with N-vinylpyrrolidone as the monomer of component (b). Without wishing to be bound by theory, it is believed that the presence of the N-vinylpyrrolidone (“VP”) monomer in the first graft copolymers according to the present disclosure provides water-solubility and good film-forming properties compared to otherwise-similar polymers that do not contain the N-vinylpyrrolidone monomer. The vinyl pyrrolidone repeat unit has amphiphilic character with a polar amide group that can form a dipole, and a non-polar portion with the methylene groups in the backbone and the ring, making it hydrophobic.

The polyalkylene oxides are grafted with a vinyl ester as the monomer of component (c). The vinyl ester may be derived from a saturated monocarboxylic acid, which may contain 1 to 6 carbon atoms, or from 1 to 3 carbon atoms, or from 1 to 2 carbon atoms, or 1 carbon atom. Suitable vinyl esters may be selected from the group consisting of vinyl formate, vinyl acetate, vinyl propionate, vinyl butyrate, vinyl valerate, vinyl iso-valerate, vinyl caproate, or mixtures thereof. Preferred monomers of component (c) include those selected from the group consisting of vinyl acetate, vinyl propionate, or mixtures thereof, preferably vinyl acetate.

Conventionally, molecular weights are expressed by their “K-values,” which are derived from relative viscosity measurements. The first graft copolymer may have a K value of from 5.0 to 200, optionally from 5.0 to 50, determined according to H. Fikentscher in 2% strength by weight solution in dimethylformamide at 25 C.

The first graft copolymer of the present disclosure may be characterized by a relatively narrow molar mass distribution. For example, the first graft copolymer may be characterized by a polydispersity M_{w}/Mₙ of less than or equal to 3.0, or less than or equal to 2.5, or less than or equal to 2.3. The polydispersity of the first graft copolymer may be from 1.5 to 2.2. The polydispersity may be determined by gel permeation chromatography using organic solvent such as hexafluoroisopropanol (HFIP) with multi-angle laser light scattering detection.

The mean molecular weight Mw of the preferred graft polymers may be from 3000 to 100,000, preferably from 6000 to 45,000, and more preferably from 8000 to 30,000 Da.

The first graft copolymer may be prepared by grafting the suitable polyalkylene oxides of component (a) with the monomers of component (b) in the presence of free radical initiators and/or by the action of high-energy radiation, which may include the action of high-energy electrons. This may be done, for example, by dissolving the polyalkylene oxide in at least one monomer of group (b), adding a polymerization initiator and polymerizing the mixture to completion. The graft polymerization may also be carried out semicontinuously by first introducing a portion, for example 10%, of the mixture of polyalkylene oxide to be polymerized, at least one monomer of group (b) and/or (c) and initiator, heating to polymerization temperature and, after the polymerization has started, adding the remainder of the mixture to be polymerized at a rate commensurate with the rate of polymerization. The first graft copolymer may also be obtained by introducing the polyalkylene oxides of group (a) into a reactor, heating to the polymerization temperature, and adding at least one monomer of group (b) and/or (c) and polymerization initiator, either all at once, a little at a time, or uninterruptedly, optionally uninterruptedly, and polymerizing.

In the preparation of the first graft copolymer, the order in which the monomers (b) and (c) are grafted onto component (a) may be immaterial and/or freely chooseable. For example, first N-vinylpyrrolidone may be grafted onto component (a), and then a monomer (c) or a mixture of monomers of group (c). It is also possible to first graft the monomers of group (c) and then N-vinylpyrrolidone onto the graft base (a). It may be that a monomer mixture of (b) and (c) are grafted onto graft base (a) in one step. The first graft copolymer may be prepared by providing graft base (a) and then first grafting N-vinylpyrrolidone and then vinyl acetate onto the graft base.

Any suitable polymerization initiator(s) may be used, which may include organic peroxides such as diacetyl peroxide, dibenzoyl peroxide, succinyl peroxide, di-tert-butyl peroxide, tert-butyl perbenzoate, tert-butyl perpivalate, tert-butyl permaleate, cumene hydroperoxide, diisopropyl peroxodicarbamate, bis(o-toluoyl) peroxide, didecanoyl peroxide, dioctanoyl peroxide, dilauroyl peroxide, tert-butyl perisobutyrate, tert-butyl peracetate, di-tert-amyl peroxide, tert-butyl peracetate, di-tert-amyl peroxide, tert-butyl hydroperoxide, mixtures thereof, redox initiators, and/or azo starters. The choice of initiator may be related to the choice of polymerization temperature.

The graft polymerization may take place at from 50° C. to 200° C., or from 70° C. to 140° C. The graft polymerization may typically be carried out under atmospheric pressure, but may also be carried out under reduced or superatmospheric pressure.

The graft polymerization may be carried out in a solvent. Suitable solvents may include: monohydric alcohols, such as ethanol, propanols, and/or butanols; polyhydric alcohols, such as ethylene glycol and/or propylene glycol; alkylene glycol ethers, such as ethylene glycol monomethyl and -ethyl ether and/or propylene glycol monomethyl and -ethyl ether; polyalkylene glycols, such as di- or tri-ethylene glycol and/or di- or tri-propylene glycol; polyalkylene glycol monoethers, such as poly(C2-C3-alkylene)glycol mono (C1-C16-alkyl)ethers having 3-20 alkylene glycol units; carboxylic esters, such as ethyl acetate and ethyl propionate; aliphatic ketones, such as acetone and/or cyclohexanone; cyclic ethers, such as tetrahydrofuran and/or dioxane; or mixtures thereof.

The graft polymerization may also be carried out in water as solvent. In such cases, the first step may be to introduce a solution which, depending on the amount of added monomers of component (b), is more or less soluble in water. To transfer water-insoluble products that can form during the polymerization into solution, it is possible, for example, to add organic solvents, for example monohydric alcohols having 1 to 3 carbon atoms, acetone, and/or dimethylformamide. In a graft polymerization process in water, it is also possible to transfer the water-insoluble graft copolymers into a finely divided dispersion by adding customary emulsifiers or protective colloids, for example polyvinyl alcohol. The emulsifiers used may be ionic or nonionic surfactants whose HLB value is from 3.0 to 13. HLB value is determined according to the method described in the paper by W. C. Griffin in J. Soc. Cosmet. Chem. 5 (1954), 249.

The amount of surfactant used in the graft polymerization process may be from 0.1 to 5.0% by weight of the graft copolymer. If water is used as the solvent, solutions or dispersions of graft copolymers may be obtained. If solutions of graft copolymers are prepared in an organic solvent or in mixtures of an organic solvent and water, the amount of organic solvent or solvent mixture used per 100 parts by weight of the graft copolymer may be from 5 to 200, optionally from to 100, parts by weight.

After the graft polymerization, the graft copolymer may optionally be subjected to a partial hydrolysis. In the graft copolymer, from 1.0 mol % to 60 mol %, preferably from 20 mol % to 60 mol %, more preferably from 30 mol % to 50 mol % of the grafted-on monomers of component (c) are hydrolyzed. For instance, the hydrolysis of graft copolymers prepared using vinyl acetate or vinyl propionate as component (c) gives graft copolymers containing vinyl alcohol units. The hydrolysis may be carried out, for example, by adding a base, such as sodium hydroxide solution or potassium hydroxide solution, or alternatively by adding acids and if necessary, heating the mixture.

### Second Graft Copolymer

The laundry composition according to the present application may comprise a second graft copolymer comprising: a) polyalkylene oxide component as a graft base; and b) polyvinyl ester component as side chains. The second graft copolymer can be present at a level of from about to about 15%, preferably from about 0.05% to about 10%, more preferably from about 0.1% to about 5%, and most preferably from about 0.2% to about 3%, e.g. 0.1%, 0.15%, 0.2%, 0.25%, 0.35%, 0.4%, 0.45%, 0.5%, 1%, 2%, or 3%, by weight of the composition.

Preferably, the second graft copolymer has an average of greater than 0 to less than or equal to 1 graft site per 50 alkylene oxide units, and/or the second graft copolymer has from 20% to 70%, preferably from 25% to 60%, by weight of said polymer of the polyalkylene oxide component and from 30% to 80%, preferably from 40% to 75%, by weight of said polymer of the vinyl ester component, and/or the second graft copolymer has a mean molar mass Mw of from 3,000 to 60,000, preferably from 6,000 to 45,000; and/or the second graft copolymer has a polydispersity of less than or equal to 3; and/or the second graft copolymer comprises less than or equal to 10% by weight of the polyvinyl ester in ungrafted form.

The polyalkylene oxide backbone of the second graft copolymer of the present invention, which is also referred to herein as the graft base, may comprise repeated units of C₂-C₁₀, preferably C₂-C₆, and more preferably C₂-C₄, alkylene oxides. For example, the polyalkylene oxide backbone may be: a polyethylene oxide (PEO) backbone; a polypropylene oxide (PPO) backbone; a polybutylene oxide (PBO) backbone; a polymeric backbone that is a linear block copolymer of PEO, PPO, and/or PBO; and combinations thereof. Preferably, the polyalkylene oxide backbone is a PEO backbone.

The second graft co-polymer(s) comprises (i) a polyalkylene oxide backbone; and (ii) at least one pendant moiety selected from polyvinyl esters of saturated C₁- to C₁₄-carboxylic acid, acrylic and or methacrylic esters of saturated monohydric alcohols contain 1 to 4 carbon atoms, and mixtures thereof. The polyalkylene oxide backbone is obtained by polymerization of at least one monomer selected from group consisting of: ethylene oxide, propylene oxide, butylene oxide. The polyalkylene oxide backbone preferably comprises predominantly ethylene oxide monomer units. Preferably, at least 50 mol %, more preferably at least 80 mol %, most preferably at least 90 mol % of the monomer units of the polyalkylene oxide backbone are obtained from ethylene oxide monomer units. The polyalkylene oxide backbone is particularly preferably obtained by the polymerization of ethylene oxide. The alkylene oxide units can be randomly distributed in the polymer or may be present in the form of blocks. Examples of such polymers being block copolymers of ethylene oxide and propylene oxide, of ethylene oxide and butylene oxide and of ethylene oxide, propylene oxide and butylene oxide.

The polyalkylene oxide backbone can have a number average molecular weight of from 500 Da to 100,000 Da, preferably from 2,000 Da to from 75,000 Da, more preferably from 4,000 Da to from 50,000 Da, most preferably from 4,000 Da to 20, 000 Da.

Preferably, the pendant moiety is derived from vinyl esters. Suitable vinyl esters are for example vinyl formate, vinyl acetate, vinyl propionate, vinyl n-butyrate, vinyl isobutyrate, vinyl valerate, vinyl i-valerate, vinyl laurate and vinyl caprolate. Preferably, the vinyl ester is vinyl acetate. It is maybe possible that up to 15% of the ester groups of the second graft co-polymer may be hydrolyzed.

Typically, the weight ratio of the polyalkylene oxide backbone to pendant is between 10:90 and 90:10, preferably from 20:80 to 80:20, more preferably from 30:70 to 70:30.

Polyethylene oxide having a number average molecular weight of from 2000 to 100,000, in particular from 4000 to 50,000, is preferably used as the grafting base. Up to 15% of the acetate groups of the graft copolymer may be hydrolyzed. Hydrolysis of the graft copolymers, which leads to graft copolymers containing vinyl alcohol units, is carried out by adding a base, such as NaOH or KOH, or an acid, and, if required, heating the mixture. The graft copolymers can have a K value according to H. Fikentscher of from 10 to 200, preferably from 20 to 100 (determined in a 1% strength by weight solution in ethyl acetate at 25° C.).

As such, a suitable second graft copolymers is polyvinyl acetate grafted polyethylene oxide copolymer, having a polyethylene oxide backbone and multiple polyvinyl acetate side chains. The molecular weight of the polyethylene oxide backbone is preferably from 4000 to 8000, more preferably about 6000, and the weight ratio of the polyethylene oxide to polyvinyl acetate is 40:60, and less than or equal to 1 grafting point per 50 ethylene oxide units. An example of such second graft co-polymers is Sokalan HP22, supplied from BASF.

Suitable second graft polymers are obtainable by grafting pendant groups such as vinyl acetate onto the polyalkylene oxide backbone, with the graft copolymerization being initiated by free radicals. For this purpose, it is possible either to use conventional polymerization initiators which decompose into free radicals under the polymerization conditions or to initiate the polymerization by high energy radiation. Examples of processes for making suitable graft copolymers are disclosed in U.S. Pat. No. 4,746,456A.

### Perfume

The detergent composition may comprise a perfume. Particularly, the perfume is in a format of a non-encapsulated perfume. The perfume can be present at a level of from about 0.001% to about 10%, preferably from about 0.005% to about 8%, more preferably from about 0.01% to about 5%, and most preferably from about 0.1% to about 2%, e.g. 0.1%, 0.15%, 0.2%, 0.25%, 0.35%, 0.4%, 0.45%, 0.5%, 0.6%, 0.7%, 0.8%, 0.9%, 1%, 1.5%, or any ranges therebetween, by weight of the composition.

Preferably, the perfume may have a ClogP of from about −2.0 and to about 8.0, more preferably a ClogP of from about 1.0 and to about 6.0; more preferably a ClogP of from about 1.0 and to about 4.0, for example 1.0, 2.0, 3.0, 4.0, 5.0, 6.0 or any ranges thereof.

Perfume in the present application may be present in a form of neat perfume (e.g. perfume oil), perfume encapsulates (e.g. perfume microcapsule), a non-encapsulated fragrance delivery systems (e.g. properfumes) or any mixtures thereof.

In some embodiments, the perfume is selected from the group consisting of geraniol; menthol; (E,Z)-2,6-nonadien-1-ol; 3,6-nonadien-1-ol; 2,2-dimethyl-3-(3-methylphenyl)propan-1-ol; 2-methyl-3-[(1,7,7-trimethylbicyclo[2.2.1]hept-2-yl)oxy]propan-1-ol; 2-methyl-4-[(1R)-2,2,3-trimethyl-3-cyclopenten-1-yl]-(2E)-buten-1-ol; ethyl trimethylcyclopentene butenol; 1-(4-propan-2-ylcyclohexyl)ethanol; 1-(2,2,6-trimethylcyclohexyl)hexan-3-ol; (Z)-3-methyl-5-(2,2,3-trimethyl-1-cyclopent-3-enyl)pent-4-en-2-ol; undecavertol; methyl dihydrojasmonate; (E,Z)-2,6-nonadien-1-al; cashmeran; iso cyclo citral; triplal; neobutenone alpha; delta damascone; alpha-pinyl isobutyraldehyde; vanillin; lilial; intreleven aldehyde; hexyl cinnamic aldehyde; adoxal; dupical; lyral; 2-tridecenal; methyl-nonyl-acetaldehyde; 4-tert-butylbenzaldehyde; dihydrocitronellal; citral; citronellal; isocyclocitral; 2,4,6-trimethoxybenzaldehyde; cuminic aldehyde; 2-methyloctanal; para tolyl acetaldehyde; o-anisaldehyde; anisic aldehyde; hexyl aldehyde; 2-methylpenanal; benzaldehyde; trans-2-hexenal; nonyl aldehyde; lauric aldehyde; beta ionone; koavone; tabanone coeur; zingerone; L-carvone; ionone gamma methyl; nectaryl; trimofix; farnesol; (E)-2-ethyl-4-(2,2,3-trimethyl-1-cyclopent-3-enyl)but-2-en-1-ol; 2-Methyl-4-[(1R)-2,2,3-trimethyl-3-cyclopenten-1-yl]-(2E)-buten-1-ol; nerol (800); ethyl vanillin; 4-(5,5,6-Trimethylbicyclo[2.2.1]hept-2-yl)cyclohexan-1-ol; octalynol 967544; (E)-3,3-dimethyl-5-(2,2,3-trimethyl-3-cyclopenten-1-yl)-4-penten-2-ol; 3-methyl-4-phenylbutan-2-ol; eugenol; 1-(2,2,6-trimethylcyclohexyl)hexan-3-ol; propenyl guaethol; 2-ethoxy-4-methylphenol; cyclopentol HC 937165; 3,7,11-Trimethyl-1,6,10-dodecatrien-3-ol; cedrol crude; 3,7-dimethyl-1,6-nonadien-3-ol (cis & trans); 1-methyl-3-(2-methylpropyl)cyclohexanol; 3,7-dimethyl-1,6-octadiene-3-ol; 2-(4-methyl-1-cyclohex-3-enyl)propan-2-ol; cyclohexanepropanol,2,2-dimethyl-, 3,7-dimethyl-1-octen-7-ol; Methyl ionone; isojasmone B 11; alpha-damascone; beta-damascone; fleuramone; 3-ethoxy-4-hydroxybenzaldehyde; formyltricyclodecan; 6-methoxy dicyclopentadiene carboxaldehyde; undecylenic aldehyde; 4-hydroxy-3-methoxybenzaldehyde; 8-,9 and 10-undecenal, mixture of isomers; trans-4-decenal; 4-dodecenal; 4-(octahydro-4,7-methano-5H-inden-5-yliden)butanal; 3-cyclohexene-1-propanal; beta, 4-dimethyl-, mandarine aldehyde 10% CITR 965765; 4,8-dimethyl-4,9-decadienal; 1-methylethyl-2-methylbutanoate; ethyl-2-methyl pentanoate; 1,5-dimethyl-1-ethenylhexyl-4-enyl acetate; p-metnh-1-en-8-yl acetate; 4-(2,6,6-trimethyl-2-cyclohexenyl)-3-buten-2-one; 4-acetoxy-3-methoxy-1-propenylbenzene; 2-propenyl cyclohexanepropionate; bicyclo[2.2.1]hept-5-ene-2-carboxylic acid, 3-(1-methylethyl)-ethyl ester; bycyclo [2.2.1]heptan-2-ol, 1,7,7-trimethyl-, acetate; 1,5-dimethyl-1-ethenylhex-4-enylacetate; hexyl 2-methyl propanoate; ethyl-2-methylbutanoate; 4-undecanone; 5-heptyldihydro-2(3h)-furanone; 1,6-nonadien-3-o1,3,7dimethyl-; 3,7-dimethylocta-1,6-dien-3-o; 3-cyclohexene-1-carboxaldehyde, dimethyl-; 3,7-dimethyl-6-octene nitrile; 4-(2,6,6-trimethyl-1-cyclohexenyl)-3-buten-2-one; tridec-2-enonitrile; patchouli oil; ethyl tricycle [5.2.1.0]decan-2-carboxylate; 2,2-dimethyl-cyclohexanepropanol; hexyl ethanoate, 7-acetyl,1,2,3,4,5,6,7,8-octahydro-1,1,6,7-tetramethyl naphtalene; allyl-cyclohexyloxy acetate; methyl nonyl acetic aldehyde; 1-spiro[4,5]dec-7-en-7-yl-4-pentenen-1-one; 7-octen-2-o1,2-methyl-6-methylene-,dihydro; cyclohexanol,2-(1,1-dimethylethyl)-, acetate; hexahydro-4,7-methanoinden-5(6)-yl propionatehexahydro-4,7-methanoinden-5(6)-yl propionate; 2-methoxynaphtalene; 1-(2,6,6-trimethyl-3-cyclohexenyl)-2-buten-1-one; 1-(2,6,6-trimethyl-2-cyclohexenyl)-2-buten-1-one; 3,7-dimethyloctan-3-ol; 3-buten-2-one,3-methyl-4-(2,6,6-trimehtyl-1-cyclohexen-2-yl)-; hexanoic acid, 2-propenyl ester; (z)-non-6-en-1-al; 1-decyl aldehyde; 1-octanal; 4-t-butyl-α-methylhydrocinnamaldehyde; alpha-hexylcinnamaldehyde; ethyl-2,4-hexadienoate; 2-propenyl 3-cyclohexanepropanoate; (5-methyl-2-propan-2-ylcyclohexyl) acetate; 3,7-dimethyloct-6-en-1-al; 2-(phenoxy)ethyl 2-methylpropanoate; prop-2-enyl 2-(3-methylbutoxy)acetate; 3-methyl-1-isobutylbutyl acetate; prop-2-enyl hexanoate; prop-2-enyl 3-cyclohexylpropanoate; prop-2-enyl heptanoate; (E)-1-(2,6,6-trimethyl-1-cyclohex-2-enyl)but-2-en-1-one; (E)-4-(2,6,6-trimethyl-1-cyclohex-2-enyl)but-3-en-2-one; (E)-3-methyl-4-(2,6,6-trimethyl-1-cyclohex-2-enyl)but-3-en-2-one; 1-(2,6,6-trimethyl-1-cyclohex-2-enyl)pent-1-en-3-one; 6,6,9a-trimethyl-1,2,3a,4,5,5a,7,8,9,9b-decahydronaphtho[2,1-Nfuran; pentyl 2-hydroxybenzoate; 7,7-dimethyl-2-methylidene-norbornane; (E)-1-(2,6,6-trimethyl-1-cyclohexenyl)but-2-en-1-one; (E)-4-(2,6,6-trimethyl-1-cyclohexenyl)but-3-en-2-one; 4-ethoxy-4,8,8-trimethyl-9-methylidenebicyclo[3.3.1]nonane; (1,7,7-trimethyl-6-bicyclo[2.2.1]heptanyl) acetate; 3-(4-tert-butylphenyl)propanal; 1,1,2,3,3-pentamethyl-2,5,6,7-tetrahydroinden-4-one; 2-oxabicyclo2.2.2octane, 1methyl4(2,2,3trimethylcyclopentyl); [(Z)-hex-3-enyl]acetate; [(Z)-hex-3-enyl] 2-methylbutanoate; cis-3-hexenyl 2-hydroxybenzoate; 3,7-dimethylocta-2,6-dienal; 3,7-dimethyloct-6-en-1-al; 3,7-dimethyl-6-octen-1-ol; 3,7-dimethyloct-6-enyl acetate; 3,7-dimethyloct-6-enenitrile; 2-(3,7-dimethyloct-6-enoxy)acetaldehyde; tetrahydro-4-methyl-2-propyl-2h-pyran-4-yl acetate; ethyl 3-phenyloxirane-2-carboxylate; hexahydro-4,7-methano-indenyl isobutyrate; 2,4-dimethylcyclohex-3-ene-1-carbaldehyde; hexahydro-4,7-methano-indenyl propionate; 2-cyclohexylethyl acetate; 2-pentylcyclopentan-1-ol; (2R,3R,4S,5S,6R)-2-R2R,3S,4R,5R,6R)-6-(6-cyclohexylhexoxy)-4,5-dihydroxy-2-(hydroxymethyl)oxan-3-yl]oxy-6-(hydroxymethyl)oxane-3,4,5-triol; (E)-1-(2,6,6-trimethyl-1-cyclohexa-1,3-dienyl)but-2-en-1-one; 1-cyclohexylethyl (E)-but-2-enoate; dodecanal; (E)-1-(2,6,6-trimethyl-1-cyclohex-3-enyl)but-2-en-1-one; (5E)-3-methylcyclopentadec-5-en-1-one; 4-(2,6,6-trimethyl-1-cyclohex-2-enyl)butan-2-one; 2-methoxy-4-prop ylphenol; methyl 2-hexyl-3-oxocyclopentane-1-carboxylate; 2,6-dimethyloct-7-en-2-ol; 4,7-dimethyloct-6-en-3-one; 4-(octahydro-4,7-methano-5H-inden-5-yliden)butanal; acetaldehyde ethyl linalyl acetal; ethyl 3,7-dimethyl-2,6-octadienoate; ethyl 2,6,6-trimethylcyclohexa-1,3-diene-1-carboxylate; 2-ethylhexanoate; (6E)-3,7-dimethylnona-1,6-dien-3-ol; ethyl 2-methylbutanoate; ethyl 2-methylpentanoate; ethyl tetradecanoate; ethyl nonanoate; ethyl 3-phenyloxirane-2-carboxylate; 1,4-dioxacycloheptadecane-5,17-dione; 1,3,3-trimethyl-2-oxabicyclo[2,2,2]octane; [essential oil]; oxacyclo-hexadecan-2-one; 3-(4-ethylphenyl)-2,2-dimethylpropanal; 2-butan-2-ylcyclohexan-1-one; 1,4-cyclohexandicarboxylic acid, diethyl ester; (3aalpha,4beta,7beta,7aalpha)-octahydro-4,7-methano-3aH-indene-3a-carboxylic acid ethyl ester; hexahydro-4-7, menthano-1H-inden-6-yl propionate; 2-butenon-1-one,1-(2,6-dimethyl-6-methylencyclohexyl)-; (E)-4-(2,2-dimethyl-6-methylidenecyclohexyl)but-3-en-2-one; 1-methyl-4-propan-2-ylcyclohexa-1,4-diene; 5-heptyloxolan-2-one; 3,7-dimethylocta-2,6-dien-1-ol; [(2E)-3,7-dimethylocta-2,6-dienyl] acetate; [(2E)-3,7-dimethylocta-2,6-dienyl] octanoate; ethyl 2-ethyl-6,6-dimethylcyclohex-2-ene-1-carboxylate; (4-methyl-1-propan-2-yl-1-cyclohex-2-enyl) acetate; 2-butyl-4,6-dimethyl-5,6-dihydro-2H-pyran; oxacyclohexadecen-2-one; 1-propanol,2-[1-(3,3-dimethyl-cyclohexyl)ethoxy]-2-methyl-propanoate; 1-heptyl acetate; 1-hexyl acetate; hexyl 2-methylpropanoate; (2-(1-ethoxyethoxy)ethyl)benzene; 4,4a,5,9b-tetrahydroindeno[1,2-d][1,3]dioxine; undec-10-enal; 3-methyl-4-(2,6,6-trimethyl-2-cyclohexen-1-yl)-3-buten-2-one; 1-(1,2,3,4,5,6,7,8-octahydro-2,3,8,8-tetramethyl-2-naphthalenyl)-ethan-1-one; 7-acetyl,1,2,3,4,5,6,7-octahydro-1,1,6,7,-tetra methyl naphthalene; 3-methylbutyl 2-hydroxybenzoate; [(1R,4S,6R)-1,7,7-trimethyl-6-bicyclo[2.2.1]heptanyl] acetate; R1R,4R,6R)-1,7,7-trimethyl-6-bicyclo[2.2.1]heptanyl] 2-methylpropanoate; (1,7,7-trimethyl-5-bicyclo[2.2.1]heptanyl) propanoate; 2-methylpropyl hexanoate; [2-methoxy-4-RE)-prop-1-enyl]phenyl] acetate; 2-hexylcyclopent-2-en-1-one; 5-methyl-2-propan-2-ylcyclohexan-1-one; 7-methyloctyl acetate; propan-2-yl 2-methylbutanoate; 3,4,5,6,6-pentamethylheptenone-2; hexahydro-3,6-dimethyl-2(3H)-benzofuranone; 2,4,4,7-tetramethyl-6,8-nonadiene-3-one oxime; dodecyl acetate; [essential oil]; 3,7-dimethylnona-2,6-dienenitrile; [(Z)-hex-3-enyl] methyl carbonate; 2-methyl-3-(4-tert-butylphenyl)propanal; 3,7-dimethylocta-1,6-dien-3-ol; 3,7-dimethylocta-1,6-dien-3-yl acetate; 3,7-dimethylocta-1,6-dien-3-yl butanoate; 3,7-dimethylocta-1,6-dien-3-yl formate; 3,7-dimethylocta-1,6-dien-3-yl 2-methylpropanoate; 3,7-dimethylocta-1,6-dien-3-yl propanoate; 3-methyl-7-propan-2-ylbicyclo[2.2.2]oct-2-ene-5-carbaldehyde; 2,2-dimethyl-3-(3-methylphenyl)propan-1-ol; 3-(4-tert-butylphenyl)butanal; 2,6-dimethylhept-5-enal; 5-methyl-2-propan-2-yl-cyclohexan-1-ol; 1-(2,6,6-trimethyl-1-cyclohexenyl)pent-1-en-3-one; methyl 3-oxo-2-pentylcyclopentaneacetate; methyl tetradecanoate; 2-methylundecanal; 2-methyldecanal; 1,1-dimethoxy-2,2,5-trimethyl-4-hexene; R1S)-3-(4-methylpent-3-enyl)-1-cyclohex-3-enyl]methyl acetate; 2-(2-(4-methyl-3-cyclohexen-1-yl)propyl)cyclo-pentanone; 4-penten-1-one, 1-(5,5-dimethyl-1-cyclohexen-1-yl; 1H-indene-ar-propanal,2,3,-dihydro-1,1-dimethyl-(9CI); 2-ethoxynaphthalene; nonanal; 2-(7,7-dimethyl-4-bicyclo[3.1.1]hept-3-enyl)ethyl acetate; octanal; 4-(1-methoxy-1-methylethyl)-1-methylcyclohexene; (2-tert-butylcyclohexyl) acetate; (E)-1-ethoxy-4-(2-methylbutan-2-yl)cyclohexane; 1,1-dimethoxynon-2-yne; [essential oil]; 2-cyclohexylidene-2-phenylacetonitrile; 2-cyclohexyl-1,6-heptadien-3-one; 4-cyclohexyl-2-methylbutan-2-ol; 2-phenylethyl 2-phenylacetate; (2E, 5E/Z)-5,6,7-trimethyl octa-2,5-dien-4-one; 1-methyl-3-(4-methylpent-3-enyl)cyclohex-3-ene-1-carbaldehyde; methyl 2,2-dimethyl-6-methylidenecyclohexane-1-carboxylate; 1-(3,3-dimethylcyclohexyl)ethyl acetate; 4-methyl-2-(2-methylprop-1-enyl)oxane; 1-spiro(4.5)-7-decen-7-yl-4-penten-1-one; 4-(2-butenylidene)-3,5,5-trimethylcyclohex-2-en-1-one; 2-(4-methyl-1-cyclohex-3-enyl)propan-2-ol; 4-isopropylidene-1-methyl-cyclohexene; 2-(4-methyl-1-cyclohex-3-enyl)propan-2-yl acetate; 3,7-dimethyloctan-3-ol; 3,7-dimethyloctan-3-ol; 3,7-dimethyloctan-3-yl acetate; 3-phenylbutanal; (2,5-dimethyl-4-oxofuran-3-yl) acetate; 4-methyl-3-decen-5-ol; undec-10-enal; (4-formyl-2-methoxyphenyl) 2-methylpropanoate; 2,2,5-trimethyl-5-pentylcyclopentan-1-one; 2-tert-butylcyclohexan-1-ol; (2-tert-butylcyclohexyl) acetate; 4-tert-butylcyclohexyl acetate; 1-(3-methyl-7-propan-2-yl-6-bicyclo[2.2.2]oct-3-enyl)ethanone; (4,8-dimethyl-2-propan-2-ylidene-3,3a,4,5,6,8a-hexahydro-1H-azulen-6-yl) acetate; [(4Z)-1-cyclooct-4-enyl] methyl carbonate; methyl beta naphtyl ether; and any mixtures thereof.

### Dye Transfer Inhibitors

The detergent composition may further comprise one or more dye transfer inhibitors (DTI) polymers. The DTI polymer can be present at the level of from about 0.001% to about 1%, preferably from about 0.005% to about 0.5%, more preferably from about 0.008% to about 0.2%, and most preferably from about 0.01% to about 0.1%, e.g. 0.01%, 0.015%, 0.02%, 0.025%, 0.03%, 0.035%, 0.04%, 0.05%, 0.06%, 0.07%, 0.08%, 0.1% or any ranges therebetween, by weight of the composition, of the DTI polymer

Suitable dye transfer inhibitors are selected from the group consisting of: polyvinylpyrrolidone polymers, polyamine N-oxide polymers, copolymers of N-vinylpyrrolidone and N-vinylimidazole, polyvinyloxazolidones, polyvinylimidazoles and mixtures thereof. Other suitable DTIs are triazines as described in WO2012/095354, polymerized benzoxazines as described in WO2010/130624, polyvinyl tetrazoles as described in DE 102009001144A, porous polyamide particles as described in WO2009/127587 and insoluble polymer particles as described in WO2009/124908. Other suitable DTIs are described in WO2012/004134, or polymers selected from the group consisting of (a) amphiphilic alkoxylated polyamines, amphiphilic graft co-polymers, zwitterionic soil suspension polymers, manganese phthalocyanines, peroxidases and mixtures thereof.

Preferred classes of DTI include but are not limited to polyvinylpyrrolidone polymers, polyamine N-oxide polymers, copolymers of N-vinylpyrrolidone and N-vinylimidazole, polyvinyloxazolidones, polyvinylimidazoles and mixtures thereof. More specifically, the polyamine N-oxide polymers preferred for use herein contain units having the following structural formula: R-AX-P; wherein P is a polymerizable unit to which an N—O group can be attached or the N—O group can form part of the polymerizable unit or the N—O group can be attached to both units; A is one of the following structures: —NC(O)—, —C(O)O—, —S—, —O—, —N═; x is 0 or 1; and R is aliphatic, ethoxylated aliphatics, aromatics, heterocyclic or alicyclic groups or any combination thereof to which the nitrogen of the N—O group can be attached or the N—O group is part of these groups. Preferred polyamine N-oxides are those wherein R is a heterocyclic group such as pyridine, pyrrole, imidazole, pyrrolidine, piperidine and derivatives thereof.

The N—O group can be represented by the following general structures:

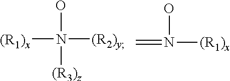

wherein R1, R2, R3 are aliphatic, aromatic, heterocyclic or alicyclic groups or combinations thereof; x, y and z are 0 or 1; and the nitrogen of the N—O group can be attached or form part of any of the aforementioned groups. The amine oxide unit of the polyamine N-oxides has a pKa<10, preferably pKa<7, more preferred pKa<6.

Any polymer backbone can be used as long as the amine oxide polymer formed is water-soluble and has dye transfer inhibiting properties. Examples of suitable polymeric backbones are polyvinyls, polyalkylenes, polyesters, polyethers, polyamide, polyimides, polyacrylates and mixtures thereof. These polymers include random or block copolymers where one monomer type is an amine N-oxide and the other monomer type is an N-oxide. The amine N-oxide polymers typically have a ratio of amine to the amine N-oxide of 10:1 to 1:1,000,000. However, the number of amine oxide groups present in the polyamine oxide polymer can be varied by appropriate copolymerization or by an appropriate degree of N-oxidation. The polyamine oxides can be obtained in almost any degree of polymerization.

Typically, the average molecular weight is within the range of 500 to 1,000,000; more preferred 1,000 to 500,000; most preferred 5,000 to 100,000. This preferred class of materials can be referred to as “PVNO”. The most preferred polyamine N-oxide useful in the detergent compositions herein is poly(4-vinylpyridine-N-oxide) which as an average molecular weight of about 50,000 and an amine to amine N-oxide ratio of about 1:4.

Copolymers of N-vinylpyrrolidone and N-vinylimidazole polymers (referred to as a class as “PVPVI”) are also preferred for use herein. Preferably the PVPVI has an average molecular weight range from 5,000 to 1,000,000, more preferably from 5,000 to 200,000, and most preferably from 10,000 to 20,000. (The average molecular weight range is determined by light scattering as described in Barth, et al., Chemical Analysis, Vol 113. “Modem Methods of Polymer Characterization”). The PVPVI copolymers typically have a molar ratio of N-vinylimidazole to N-vinylpyrrolidone from 1:1 to 0.2:1, more preferably from 0.8:1 to 0.3:1, most preferably from to 0.4:1.

These copolymers can be either linear or branched.

The present invention compositions also may employ a polyvinylpyrrolidone (“PVP”) having an average molecular weight of from about 5,000 to about 400,000, preferably from about to about 200,000, and more preferably from about 5,000 to about 50,000. PVP's are known to persons skilled in the detergent field; see, for example, EP-A-262,897 and EP-A-256,696, incorporated herein by reference. Compositions containing PVP can also contain polyethylene glycol (“PEG”) having an average molecular weight from about 500 to about 100,000, preferably from about 1,000 to about 10,000. Preferably, the ratio of PEG to PVP on a ppm basis delivered in wash solutions is from about 2:1 to about 50:1, and more preferably from about 3:1 to about 10:1.

Suitable examples include PVP-K15, PVP-K30, ChromaBond S-400, ChromaBond S-403E and Chromabond S-100 from Ashland, and Sokalan® HP165, Sokalan® HP50, Sokalan® HP53, Sokalan® HP59, Sokalan® HP 56K, Sokalan® HP 66 from BASF; Reilline 4140 from Vertellus.

### Surfactant System

Preferably, the composition may comprise from 4% to 80%, preferably from 6% to 50%, more preferably from 10% to 30%, e.g., 5%, 10%, 15%, 20%, 25%, 30%, 35%, 40%, 45%, 50% or any ranges therebetween, by weight of the composition, of a surfactant system. Particularly, the surfactant system may comprise an anionic surfactant and a nonionic surfactant.

The anionic surfactant suitable for the composition in the present invention may be selected from the group consisting of C₆-C₂₀ linear alkylbenzene sulfonates (LAS), C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), and any combinations thereof. For example, the laundry detergent composition may contain a C₆-C₂₀ alkyl alkoxy sulfates (AAₓS), wherein x is about 1-30, preferably about 1-15, more preferably about 1-10, most preferably x is about 1-3. The alkyl chain in such AAXS can be either linear or branched, with mid-chain branched AAXS surfactants being particularly preferred. A preferred group of AAₓS include C₁₂-C₁₄ alkyl alkoxy sulfates with x of about 1-3. In some embodiments, the composition comprises from 1% to 30%, preferably from 2% to 25%, more preferably from 3% to 20%, for example, 4%, 5%, 6%, 7%, 8%, 9%, 10%, 12%, 14%, 16%, 18%, 20%, or any ranges therebetween, by weight of the composition of the anionic surfactant.

The nonionic surfactant suitable for the composition in the present invention may be selected from the group consisting of alkyl alkoxylated alcohols, alkyl alkoxylated phenols, alkyl polysaccharides, polyhydroxy fatty acid amides, alkoxylated fatty acid esters, sucrose esters, sorbitan esters and alkoxylated derivatives of sorbitan esters, and any combinations thereof. Non-limiting examples of nonionic surfactants suitable for use herein include: C₁₂-C₁₈ alkyl ethoxylates, such as Neodol® nonionic surfactants available from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block alkyl polyamine ethoxylates such as Pluronic® available from BASF; C₁₄-C₂₂ mid-chain branched alkyl alkoxylates, BAEx, wherein x is from about 1 to about 30; alkylpolysaccharides, specifically alkylpolyglycosides; polyhydroxy fatty acid amides; and ether capped poly(oxyalkylated) alcohol surfactants. Also useful herein as nonionic surfactants are alkoxylated ester surfactants such as those having the formula R¹C(O)O(R₂O)ₙR³ wherein R¹ is selected from linear and branched C₆-C₂₂ alkyl or alkylene moieties; R² is selected from C₂H₄ and C₃H₆ moieties and R³ is selected from H, CH₃, C₂H₅ and C₃H₇ moieties; and n has a value between about 1 and about 20. Such alkoxylated ester surfactants include the fatty methyl ester ethoxylates (MEE) and are well-known in the art. In some particular embodiments, the alkoxylated nonionic surfactant contained by the laundry detergent composition of the present invention is a C₆-C₂₀ alkoxylated alcohol, preferably C₅-C₁₈ alkoxylated alcohol, more preferably C₁₀-C₁₆ alkoxylated alcohol. The C₆-C₂₀ alkoxylated alcohol is preferably an alkyl alkoxylated alcohol with an average degree of alkoxylation of from about 1 to about 50, preferably from about 3 to about 30, more preferably from about 5 to about even more preferably from about 5 to about 9. In some embodiments, the composition comprises from 1% to 30%, preferably from 2% to 25%, more preferably from 3% to 20%, for example, 4%, 5%, 6%, 7%, 8%, 9%, 10%, 12%, 14%, 16%, 18%, 20%, or any ranges therebetween, by weight of the composition of the nonionic surfactant.

The ratio of anionic surfactant to nonionic surfactant may be between 0.01 and 100, preferably between 0.05 and 20, more preferably between 0.1 and 10, and most preferably between and 5.

In some embodiments, the anionic surfactant comprises a C₆-C₂₀ linear alkylbenzene sulfonate surfactant (LAS), preferably C₁₀-C₁₆ LAS, and more preferably C₁₂-C₁₄ LAS. In some particular embodiments of the present invention, the anionic surfactant may be present as the main surfactant, preferably as the majority surfactant, in the composition. Preferably, the ratio of anionic surfactant to nonionic surfactant may be between 1.05 and 100, preferably between 1.1 and 20, more preferably between 1.2 and 10, and most preferably between 1.3 and 5. Particularly, the anionic surfactant may comprise C₆-C₂₀ linear alkylbenzene sulfonates (LAS).

In some particular embodiments of the present invention, the nonionic surfactant may be present as the main surfactant, preferably as the majority surfactant, in the composition. Preferably, the ratio of anionic surfactant to nonionic surfactant may be between 0.01 and 0.95, preferably between 0.05 and 0.9, more preferably between 0.1 and 0.85, and most preferably between 0.2 and Particularly, the nonionic surfactant may comprise C₆-C₂₀ alkoxylated alcohol.

The laundry detergent composition of the present invention may further comprise a cationic surfactant. Non-limiting examples of cationic surfactants include: quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; and amino surfactants, specifically amido propyldimethyl amine (APA).

The laundry detergent composition of the present invention may further comprise an amphoteric surfactant. Non-limiting examples of amphoteric surfactants include: amine oxides, derivatives of secondary and tertiary amines, derivatives of heterocyclic secondary and tertiary amines, or derivatives of quaternary ammonium, quaternary phosphonium or tertiary sulfonium compounds. Preferred examples include: C₆-C₂₀ alkyldimethyl amine oxides, betaine, including alkyl dimethyl betaine and cocodimethyl amidopropyl betaine, sulfo and hydroxy betaines, such as N-alkyl-N,N-dimethylammino-1-propane sulfonate where the alkyl group can be C₈-C₁₈ or C₁₀-C₁₄.

### Other Ingredients

The laundry detergent composition of the present invention may further comprise a cationic surfactant. Non-limiting examples of cationic surfactants include: quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; and amino surfactants, specifically amido propyldimethyl amine (APA).

The laundry detergent composition herein may comprise adjunct ingredients. Suitable adjunct materials include but are not limited to: builders, chelating agents, rheology modifiers, dye transfer inhibiting agents, dispersants, enzymes, and enzyme stabilizers, anti-oxidants, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, perfumes, perfume microcapsules, structure elasticizing agents, fabric softeners, carriers, hydrotropes, processing aids, solvents, hueing agents, structurants and/or pigments. The precise nature of these adjunct ingredients and the levels thereof in the laundry detergent composition will depend on the physical form of the composition and the nature of the cleaning operation for which it is to be used.

In some embodiments, the laundry detergent composition according to the present disclosure may further comprise from 0.01% to 10%, preferably from 0.1% to 5%, more preferably from 0.2% to 4%, most preferably from 0.3% to 3%, for example, 0.5%, 1%, 2%, 3%, 4%, 5% or any ranges thereof, by weight of the composition, of a fatty acid.

### Composition Preparation

The laundry detergent composition of the present invention is generally prepared by conventional methods such as those known in the art of making laundry detergent compositions. Such methods typically involve mixing the essential and optional ingredients in any desired order to a relatively uniform state, with or without heating, cooling, application of vacuum, and the like, thereby providing laundry detergent compositions containing ingredients in the requisite concentrations.

### Method of Use

Another aspect of the present invention is directed to a method of using the laundry detergent composition to treat a fabric. Such method can deliver a color protection benefit. The method comprises the step of administering from 5 g to 120 g of the above-mentioned laundry detergent composition into a laundry washing basin comprising water to form a washing solution. The washing solution in a laundry washing basin herein preferably has a volume from 1 L to 65 L, alternatively from 1 L to 50 L, alternatively from 1 L to 20 L for hand washing and from 10 L to 50 L for machine washing. The temperatures of the laundry washing solution preferably range from 5° C. to 60° C.

In some embodiments, the composition is added to a washing machine via a dispenser (e.g. a dosing drawer). In some other embodiments, the composition is added to an automatic dosing washing machine via an automatic dosing mechanism. In some other embodiments, the composition is added to directly a drum of a washing machine. In some other embodiments, the composition is added directly to the wash liquor.

The dosing amount in the method herein may be different depending on the washing type. In one embodiment, the method comprises administering from about 5 g to about 60 g of the laundry detergent composition into a hand washing basin (e.g., about 2-4 L). In an alternative embodiment, the method comprises administering from about 5 g to about 100 g, preferably from about 10 g to about 65 g of the laundry detergent composition into a washing machine (e.g., about L).

### Test Method

### Test 1: Perfume Deposition Test

Before testing for perfume deposition, the test fabrics are prepared and treated according to the procedure described below. Fabrics are typically “de-sized” and/or “stripped” of any manufacturer's finish that may be present and pre-conditioned with fabric enhancer according to A, dried, cut into fabric specimens and then treated with a detergent composition in a tergotometer.

A. Fabric Preparation Method.

Fabrics may be prepared according to one or both of the following methods.

A1. Fabric De-sizing Method. New fabrics are de-sized by washing two cycles at 49° C. (120° F.), using zero grain water in a top loading washing machine such as Kenmore 80 series. All fabrics are tumble-dried after the second cycle for 45 minutes on cotton/high setting in a Kenmore series dryer.

A2. Fabric Pre-conditioning Method. De-sized fabrics are pre-conditioned with detergent and liquid fabric softener by washing for 3 cycles at 32° C. using 6 grain per gallon water in a top loading washing machine such as Kenmore 80 series. The detergent (Tide®, 83 g) is added to the drum of the washing machine after the water has filled at the beginning of the wash cycle, followed by 2.5 kg of de-sized 100% cotton terry towels (30.5 cm×30.5 cm, RN37000-ITL available from Calderon Textiles, LLC6131 W 80th St Indianapolis IN). Liquid fabric softener (Downy®, 46 g) is added to the drum during the rinse cycle once the rinse water has filled. All fabrics are tumble-dried after the second cycle for 45 minutes on cotton/high setting in a Kenmore series dryer. Each treated fabric is die-cut into 1.4 cm-diameter circle test specimens using a pneumatic press (Atom Clicker Press SE20 C available from Manufacturing Suppliers Services, Cincinnati, OH).

B. Fabric Treatment Method in a Tergotometer.

The tergotometer is filled to a 1 L fill volume and is programmed for a 12 min agitation time, and a 10 min rinse cycle with an agitation speed of 300 rpm using 15 gpg/30° C. water for the wash and 15 gpg/25° C. (77° F.) water for the rinse with agitation sweep angle of 15°. Water is removed by centrifugation for 2 min at 1500 rpm after the washing and rinsing steps. The Detergent Composition (1.5 g) is added to the washing pot after the water is filled to 350 g and then agitated for 60 s. The pre-conditioned fabrics (8×1.4 cm diameter circles) are added to glass sample vial (#24694, available from Restek, Bellefonte, PA), the weight is recorded (8×1.4 cm circles weigh about 0.63 g±0.07 g), and the vial is capped (#093640-094-00 available from Gerstel, Linthicum, MD). Once the detergent, and all test fabrics are added to the Tergotometer pot, the timed cycle begins. After the washing cycle is complete, the fabrics are removed, and dried for 30 min/62° C. For each perfume deposition analysis, 12 replicates are prepared according to the method above and analyzed.

Fabric Perfume Deposition analysis is performed using Solid-phase Micro Extraction Gas Chromatography Mass Spectrometry (SPME GC-MS) described below. Perfume deposition analysis is carried out on treated 100% cotton terry towels (RN37000ITL, Calderon Textiles, LLC, Indianapolis, IN, USA) that have been prepared and treated according to the fabric preparation method that is described above.

Perfume deposition analysis is done on 8 treated fabrics from 12 different vials for a total of 96 fabrics divided into six vials containing treated fabrics from two replicates. Dried fabrics from two replicates are combined in a 20 mL VOA vial (#10854-102, available from Avantor, Radnor, PA) for a total mass of about 1.25 g (±0.15 g) of fabric in each of six vials. Perfume deposition results are reported as an average from these 6 vials.

The determination of the amount of perfume deposited onto treated fabric requires the extraction of the perfume. The extraction of the perfume is performed utilizing a liquid extraction followed by GC-MS quantification described above.

An equal mass of untreated fabric is spiked with a known amount of a known perfume mixture and analyzed to create a multipoint calibration. The perfume is extracted from the treated fabrics in the sealed extraction vial using methanol (8 mL) and heat (35° C.) in a 45-minute extraction. After 45 minutes, remove vials and vortex mix for 15 seconds at 2600 rpm. Vials are allowed to cool to room temperature. 500 microliter aliquot of the methanol collected in VOA vials is added to 4.5 mL of a 20% NaCl in deionized water solution (5 mL total solution) in a 20 mL headspace vial (#10854-102, available from Avantor, Radnor, PA).

The sample vials containing the 5 mL of solution are then loaded onto a Gerstel MPS2 Autosampler (Gerstel Inc., Linthicum, MD, USA). Prior to the headspace analysis, each sample is pre-conditioned in the machine at 65° C. for 10 minutes. Headspace is extracted onto the Agilent 7890B/5977A GC-MS system (Agilent Technologies, Santa Clara, CA, USA) equipped with a Supelco 100 micrometer PDMS 23Ga. Solid Phase Micro Extraction fiber (Supelco Inc., Bellefonte, PA, USA). GC analysis is conducted on a non-polar capillary column (DB-5MS UI, meters nominal diameter, 0.25 millimeter nominal diameter, 25 micrometer thickness) and the headspace constituents (i.e. the perfume raw materials) are monitored by Mass Spectrometry (EI, detector). Perfume concentration is calculated utilizing a multi-point calibration of the perfume raw materials from the spiked fabrics. The total deposition is the sum of each detected perfume raw material divided by the mass of the fabric. Deposition efficiency is calculated by dividing the extracted perfume per gram of fabric by the total encapsulated perfume delivered to the washing machine divided by the total mass of the fabric load and is reported as a percentage.

### EXAMPLES

### Synthesis Example 1: Synthesis of Graft Copolymer

A polymerization vessel equipped with stirrer and reflux condenser was initially charged with 720 g of PEG (6000 g/mol) and 60 g 1,2-propane diol (MPG) under nitrogen atmosphere. The mixture was homogenized at 70° C.

Then, 432 g of vinyl acetate (in 2 h), 288 g of vinylpyrrolidone in 576 g of MPG (in 5 h), and 30.2 g of tert.-butyl perpivalate in 196.6 g MPG (in 5.5 h) were metered in. Upon complete addition of the feeds, the solution was stirred at 70° C. for 1 h. Subsequently, 3.8 g tert.-butyl perpivalate in 25.0 g MPG (in 1.5 h) were metered in followed by 0.5 h of stirring.

The volatiles were removed by vacuum stripping. Then, 676.8 g deionized water were added and a steam distillation was conducted at 100° C. for 1 h.

The temperature of the reaction mixture was reduced to 80° C. and 160.6 g of aqueous sodium hydroxide solution (50%, 40 mol % respective VAc) was added with maximum feed rate. Upon complete addition of the sodium hydroxide solution, the mixture was stirred for 1 h at 80° C. and subsequently cooled to ambient temperature.

The resulting graft polymer is characterized by a K-value of 24. The solid content of the final solution is 45%.

### Example 1: Improved Deposition of Perfume onto Fabrics by Adding Two Graft Copolymers in Laundry Detergent Composition

Six (6) sample liquid laundry detergent compositions were prepared containing the following ingredients as shown in Table 1. Sample 1 does not contain any graft copolymer. Sample 2 contains the second graft copolymer only. Samples 3 to 6 contain both the graft copolymer and the second graft copolymer according to the present application with the same ratio (3:2) at different levels.

TABLE 1

| Ingredients | | | | | | |
|---|---|---|---|---|---|---|
| (weight %) | Sample 1 | Sample 2 | Sample 3 | Sample 4 | Sample 5 | Sample 6 |
| First Graft | — | — | 0.34% | 0.55% | 1.09% | 1.64% |
| copolymer¹ | | | | | | |
| Second Graft | — | 0.57% | 0.23% | 0.36% | 0.73% | 1.09% |
| copolymer² | | | | | | |
| C₁₂-₁₄AE₁₋₃S | 3.0% | 3.0% | 3.0% | 3.0% | 3.0% | 3.0% |
| C₁₁-₁₃LAS | 2.9% | 2.9% | 2.9% | 2.9% | 2.9% | 2.9% |
| C₁₂-₁₄EO₇ | 2.7% | 2.7% | 2.7% | 2.7% | 2.7% | 2.7% |
| C₁₂-C₁₈ Fatty Acid | 2.7% | 2.7% | 2.7% | 2.7% | 2.7% | 2.7% |
| Perfume | 1% | 1% | 1% | 1% | 1% | 1% |
| Additional | Balance | Balance | Balance | Balance | Balance | Balance |
| ingredients | | | | | | |
| (including water) | | | | | | |

¹First Graft Copolymer: Graft copolymer described in Synthesis Example 1 with PVP/PVAc-g-PEG at 20:30:50 by weight ratio with weight-average MW 16,800 Dalton.
²Second Graft Copolymer: Polyvinyl acetate grafted polyethylene oxide copolymer having a polyethyleneoxide backbone and multiple polyvinyl acetate side chains, supplied by BASF, Germany.

In accordance with Test 1: Perfume Deposition Test as described hereinabove, the content of perfume deposited onto fabrics washed by using these samples were measured.

The results are shown in the table below, in which the liquid laundry detergent compositions containing both the first and second graft copolymers show significantly higher deposition of perfume on fabrics after being washed compared to the liquid laundry detergent composition containing only the second graft copolymer or no graft copolymer. This discovery is surprising because previous data shows the first graft copolymer only cannot significantly improve the deposition of perfume on fabrics after being washed. Even more unexpectedly, Sample 3 containing a relatively low level of total graft copolymer (0.57%) shows surprisingly higher deposition of perfume compared to Sample 5 (1.8%) or 6 (2.7%).

TABLE 2

| | Sample 1 | Sample 2 | Sample 3 | Sample 4 | Sample 5 | Sample 6 |
|---|---|---|---|---|---|---|
| | a | b | c | d | e | f |
| Total perfume | 18.2 | 25.6a | 30.5aef | 27.0f | 25.1a | 24.4a |
| deposition (μg/g) | | | | | | |
| Total copolymer | — | 0.57% | 0.57% | 0.91% | 1.82% | 2.73% |
| content | | | | | | |

### Example 2: Exemplary Formulations of Laundry Detergent Compositions

The following liquid laundry detergent compositions as shown in Table 3a to 3c are made comprising the listed ingredients in the listed proportions (weight %).

TABLE 3a

| Ingredients | | | | | | |
|---|---|---|---|---|---|---|
| (weight %) | A | B | C | D | E | F |
| C₁₂-₁₄AE₁₋₃S | 4 | 1.5 | 3 | 1 | 4 | 1.5 |
| C₁₁-₁₃LAS | 2 | 3 | 5 | 1 | 2 | 3 |
| C₁₄-₁₅EO₇ | 10 | 8.5 | 15 | 12 | 5 | — |
| C₁₂-₁₄EO₇ | — | — | — | — | — | 8 |
| First Graft Copolymer¹ | 0.05 | 0.09 | 0.17 | 0.13 | 0.15 | 0.29 |
| Second Graft Copolymer² | 0.02 | 0.05 | 0.10 | 0.12 | 0.08 | 0.29 |
| Citric acid | 2.4 | 0.5 | 4.8 | 0.6 | — | 2 |
| C₁₂-C₁₈ fatty acid | 3.2 | 1.2 | 2.2 | 2 | 1.5 | 1.2 |
| Na-DTPA | 1 | 0.05 | 0.5 | 0.18 | 0.06 | 0.2 |
| Sodium cumene sulphonate | — | — | — | 4.42 | — | — |
| Ethanol | — | — | — | 1.74 | — | — |
| Silicone emulsion | — | 0.0025 | 0.0025 | 0.0025 | — | 0.0025 |
| Sodium polyacrylate | 1.4 | — | — | — | 1.4 | — |
| Polyethyleneimines | — | — | 1.0 | — | — | — |
| NaOH | Up to | Up to | Up to | Up to | Up to | Up to |
| | pH 8 | pH 8 | pH 8 | pH 8 | pH 8 | pH 8 |
| Na Formate | — | — | — | 0.02 | — | — |
| Protease | — | — | 0.45 | 0.29 | — | — |
| Amylase | — | — | 0.08 | — | — | — |
| Dye | — | 0.002 | 0.002 | 0.001 | — | 0.002 |
| Perfume oil | 0.2 | 0.6 | 0.6 | 0.57 | 0.1 | 0.6 |
| Water | Balance | Balance | Balance | Balance | Balance | Balance |

¹First Graft Copolymer: Graft copolymer described in Synthesis Example 1 with PVP/PVAc-g-PEG at 20:30:50 by weight ratio with weight-average MW 16,800 Dalton.
²Second Graft Copolymer: Polyvinyl acetate grafted polyethylene oxide copolymer having a polyethyleneoxide backbone and multiple polyvinyl acetate side chains, supplied by BASF, Germany.

TABLE 3b

| Ingredients | | | | | | |
|---|---|---|---|---|---|---|
| (weight %) | G | H | I | J | K | L |
| C₁₂-₁₄AE₁₋₃S | 9 | 10 | 12 | 3 | 4 | 1.5 |
| C₁₁-₁₃LAS | 2 | 3 | 5 | 12 | 9 | 15 |
| C₁₄-₁₅EO₇ | 5 | — | — | 3 | — | — |
| C₁₂-₁₄EO₇ | — | 3 | 4 | — | 3 | 8 |
| First Graft Copolymer¹ | 0.5 | 0.9 | 0.7 | 0.3 | 0.5 | 0.9 |
| Second Graft Copolymer² | 1 | 2 | 5 | 0.5 | 0.7 | 3 |
| Citric acid | 2.4 | 0.5 | 4.8 | 0.6 | — | 2 |
| C₁₂-C₁₈ fatty acid | 3.2 | 1.2 | 2.2 | 2 | 1.5 | 1.2 |
| Na-DTPA | 1 | 0.05 | 0.5 | 0.18 | 0.06 | 0.2 |
| Sodium cumene sulphonate | — | — | — | 4.42 | — | — |
| Ethanol | — | — | — | 1.74 | — | — |
| Silicone emulsion | — | 0.0025 | 0.0025 | 0.0025 | — | 0.0025 |
| Sodium polyacrylate | 1.4 | — | — | — | 1.4 | — |
| Polyethyleneimines | — | — | 1.0 | — | — | — |
| NaOH | Up to | Up to | Up to | Up to | Up to | Up to |
| | pH 8 | pH 8 | pH 8 | pH 8 | pH 8 | pH 8 |
| Na Formate | — | — | — | 0.02 | — | — |
| Protease | — | — | 0.45 | 0.29 | — | — |
| Amylase | — | — | 0.08 | — | — | — |
| Dye | — | 0.002 | 0.002 | 0.001 | — | 0.002 |
| Perfume oil | 0.5 | 2.0 | 0.6 | 1.5 | 1.2 | 0.8 |
| Water | Balance | Balance | Balance | Balance | Balance | Balance |

¹First Graft Copolymer: Graft copolymer described in Synthesis Example 1 with PVP/ PVAc-g-PEG at 20:30:50 by weight ratio with weight-average MW 16,800 Dalton.
²Second Graft Copolymer: Polyvinyl acetate grafted polyethylene oxide copolymer having a polyethyleneoxide backbone and multiple polyvinyl acetate side chains, supplied by BASF, Germany

TABLE 3c

| Ingredients | | | | | | |
|---|---|---|---|---|---|---|
| (weight %) | M | N | O | P | Q | R |
| C₁₂-₁₄AE₁₋₃S | 2.5 | 7.0 | 7.0 | 4.2 | 3.0 | 3.9 |
| C₁₂-₁₄AS | 1.0 | 5.3 | 5.3 | 1.2 | — | — |
| C₁₁-₁₃LAS | 10.7 | 9.7 | 9.7 | 5.4 | 4.2 | 3.9 |
| C₁₂-₁₄EO₇ | 10.8 | 6.2 | 6.2 | 5.4 | 3.0 | 5.9 |
| First Graft Copolymer¹ | 0.3 | 1.0 | 0.5 | 1.2 | 0.4 | 0.9 |
| Second Graft Copolymer² | 0.2 | 0.3 | 0.5 | 0.4 | 0.2 | 0.3 |
| C₁₂-C₁₈ fatty acid | — | — | 2.0 | — | 2.6 | 1.1 |
| Na-DTPA | 0.05 | 0.05 | 0.05 | 0.18 | 0.64 | 0.09 |
| NaOH | Up to | Up to | Up to | Up to | Up to | Up to |
| | pH 8 | pH 8 | pH 8 | pH 8 | pH 8 | pH 8 |
| Perfume oil | 1.2 | 1.0 | 0.75 | 1.5 | 1.0 | 0.8 |
| Additional ingredients | Balance | Balance | Balance | Balance | Balance | Balance |
| (including water) | | | | | | |

¹First Graft Copolymer: Graft copolymer described in Synthesis Example 1 with PVP/ PVAc-g-PEG at 20:30:50 by weight ratio with weight-average MW 16,800 Dalton.
²Second Graft Copolymer: Polyvinyl acetate grafted polyethylene oxide copolymer having a polyethyleneoxide backbone and multiple polyvinyl acetate side chains, supplied by BASF, Germany

### Example 3: Exemplary Formulations of Unite Dose Laundry Detergent Compositions

The exemplary formulations as shown in Table 4 are made for unit dose laundry detergent. These compositions are encapsulated into compartment(s) of the unit dose by using a polyvinyl-alcohol-based film.

TABLE 4

| Ingredients | | | | | | | |
|---|---|---|---|---|---|---|---|
| (weight %) | S | T | U | V | W | X | Y |
| C₁₁-C₁₃ LAS | 8 | 6 | 5 | 1 | 8 | 6 | 5 |
| C₁₂-C₁₄AE₃S | 6 | 10 | 5 | 2 | 6 | 10 | 5 |
| C₁₄-C₁₅EO7 | — | 6 | — | — | 9 | 10 | 11 |
| C₁₂-C₁₄EO7 | 18 | 25 | 16 | 18 | 9 | 15 | 5 |
| First Graft | 2 | 0.1 | 0.5 | 1.7 | 0.2 | 0.4 | 1.5 |
| Copolymer¹ | | | | | | | |
| Second Graft | 1 | 0.2 | 1.5 | 0.7 | 1.0 | 2.0 | 1.5 |
| Copolymer² | | | | | | | |
| Citric acid | 0.5 | 0.7 | 1.1 | 0.5 | 0.5 | 0.7 | 1.1 |
| C₁₂-C₁₈ fatty acid | 0.5 | 2.4 | 0.5 | 4.8 | 0.5 | 2.4 | 0.5 |
| Sodium cumene | 1.3 | — | 1.3 | 1.3 | 1.3 | 1.3 | 1.3 |
| sulphonate | | | | | | | |
| Perfume oil | 0.3 | 1.5 | 2.5 | 3.0 | 4.0 | 0.8 | 1.0 |
| Solvent | Balance | Balance | Balance | Balance | Balance | Balance | Balance |

1First Graft Copolymer: Graft copolymer described in Synthesis Example 1 with PVP/ PVAc-g-PEG at 20:30:50 by weight ratio with weight-average MW 16,800 Dalton.
²Second Graft Copolymer: Polyvinyl acetate grafted polyethylene oxide copolymer having a polyethyleneoxide backbone and multiple polyvinyl acetate side chains, supplied by BASF, Germany

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry detergent composition, comprising:
1) a first graft copolymer comprising:
a) polyalkylene oxide as a graft base which has a number average molecular weight of from about 1000 to about 20,000 Daltons and is based on ethylene oxide, propylene oxide, butylene oxide, or a mixture thereof;
b) N-vinylpyrrolidone as side chains; and
c) vinyl ester component as side chains which is derived from a saturated monocarboxylic acid containing from 1 to 6 carbon atoms and/or a methyl or ethyl ester of acrylic or methacrylic acid;
wherein the weight ratio of (a):(b) is from about 1:0.1 to about 1:2, and
wherein the amount, by weight, of (a) is greater than the amount of (c);
2) a second graft copolymer comprising:
i) polyalkylene oxide component as a graft base; and
ii) vinyl ester component as side chains;
and
3) a perfume.

2. The laundry detergent composition according to claim 1, wherein the weight ratio of the first graft copolymer to the second graft copolymer is from about 20:1 to about 1:20.

3. The laundry detergent composition according to claim 1, wherein the weight ratio of the first graft copolymer to the second graft copolymer is about 5:1 to about 1:5.

4. The laundry detergent composition according to claim 1, wherein the weight ratio of the first graft copolymer to the second graft copolymer is from about 3:1 to about 1:3.

5. The laundry detergent composition according to claim 1, wherein the total amount of the first graft copolymer and the second graft copolymer in the laundry detergent composition is from about 0.05% to about 3.0%, by weight of the composition.

6. The laundry detergent composition according to claim 1, wherein the total amount of the first graft copolymer and the second graft copolymer in the laundry detergent composition is from about 0.2% to about 1%, by weight of the composition.

7. The laundry detergent composition according to claim 1, wherein the weight ratio of the first graft copolymer to the second graft copolymer is from about 3:1 to about 1:3, and the total amount of the first graft copolymer and the second graft copolymer in the laundry detergent composition is from about 0.2% to about 1%, by weight of the composition.

8. The laundry detergent composition according to claim 1, wherein in the graft polymer
a) the polyalkylene oxide comprises ethylene oxide units or ethylene oxide units and propylene oxide units, and
b) the vinyl ester comprises vinyl acetate.

9. The laundry detergent composition according to claim 1, wherein in the graft polymer
a) the polyalkylene oxide consists of ethylene oxide units or ethylene oxide units and propylene oxide units, and
b) the vinyl ester consists of vinyl acetate.

10. The laundry detergent composition according to claim 1, wherein in the first graft copolymer, the polyalkylene oxide has a number average molecular weight of from about 2000 to about 15,000 Daltons.

11. The laundry detergent composition according to claim 1, wherein in the graft polymer, the weight ratio of (a):(c) is from about 1.0:0.1 to about 1.0:0.99.

12. The laundry detergent composition of claim 1, wherein in the graft polymer, the weight ratio of (a):(c) is from about 1.0:0.3 to about 1.0:0.9.

13. The laundry detergent composition according to claim 1, wherein in the first graft copolymer, from about 30 mol % to about 50 mol % of the grafted-on monomers of component (c) are hydrolysed.

14. The laundry detergent composition according to claim 1, wherein the first graft copolymer has a weight average molecular weight of from about 8,000 Da to about 20,000 Da.

15. The laundry detergent composition according to claim 1, wherein said second graft copolymer has an average of greater than 0 to less than or equal to 1 graft site per 50 alkylene oxide units, and/or
wherein said second graft copolymer has from about 25% to about 60%, by weight of said polymer of the polyalkylene oxide component and from about 40% to about 75%, by weight of said polymer of the vinyl ester component, and/or
wherein said second graft copolymer has a mean molar mass Mw of from about 6,000 to about 45,000; and/or
wherein said second graft copolymer has a polydispersity of less than or equal to 3; and/or
wherein said second graft copolymer comprises less than or equal to about 10% by weight of the polyvinyl ester in ungrafted form; and/or
wherein said second graft copolymer comprises side chains consisting of the vinyl ester component.

16. The laundry detergent composition according to claim 1, wherein the composition comprises:
from about 0.1% to about 1%, by weight of the composition, of the first graft copolymer, and/or
from about 0.1% to about 1%, by weight of the composition, of the second graft copolymer, and/or
from about 0.008% to about 2%, by weight of the composition, of the perfume.

17. The laundry detergent composition according to claim 1, further comprises from 0.1% to 70%, by weight of the composition, of a surfactant.

18. The laundry detergent composition according to claim 17, wherein the surfactant comprises C₆-C₂₀ linear alkylbenzene sulfonate, C₆-C₂₀ alkyl alkoxy sulfates, C₆-C₂₀ alkoxylated alcohol, or any mixtures thereof.

19. The laundry detergent composition according to claim 1, wherein said composition is in the form of a liquid composition, a granular composition, a single-compartment pouch, a multi-compartment pouch, a sheet, a pastille or bead, a fibrous article, a tablet, a bar, flake, or a mixture thereof.

20. A method of treating textile, the method comprising the steps of: (i) treating a textile with a laundry detergent composition according to claim 1; and (ii) treating the textile with a fabric enhancer composition comprising a perfume.
